(19) United States
(12) Patent Application Publication
(10) Pub. No.: US 2025/0095354 A1
(43) Pub. Date: Mar. 20, 2025

(54) VOXEL-LEVEL FEATURE FUSION WITH GRAPH NEURAL NETWORKS AND DIFFUSION FOR 3D OBJECT DETECTION

(71) Applicant: QUALCOMM Incorporated, San Diego, CA (US)

(72) Inventors: Varun Ravi Kumar, San Diego, CA (US); Debasmit Das, San Diego, CA (US); Senthil Kumar Yogamani, Headford (IE)

(21) Appl. No.: 18/467,657

(22) Filed: Sep. 14, 2023

(51) Int. Cl. G06V 10/86; G06T 3/00; G06T 5/00; G06T 7/194; G06T 7/55; G06V 10/80; G06V 10/82; G06V 20/58

(52) U.S. Cl. CPC G06V 10/86; G06T 3/04; G06T 5/70; G06T 7/194; G06T 7/55; G06V 10/806; G06V 10/82; G06V 20/58; G06T 2207/10028; G06T 2207/20021; G06T 2207/20084; G06T 2207/20221; G06T 2207/30252

(57) ABSTRACT

An apparatus includes a memory and processing circuitry in communication with the memory. The processing circuitry is configured to process a joint graph representation using a graph neural network (GNN) to form an enhanced graph representation. The joint graph representation includes first features from a voxelized point cloud, and second features from a plurality of camera images. The enhanced graph representation includes enhanced first features and enhanced second features. The processing circuitry is further configured to perform a diffusion processes on the enhanced first features and the enhanced second features of the enhanced graph representation to form a denoised graph representation having denoised first features and denoised second features, and fuse the denoised first features and the denoised second features of the denoised graph representation using a graph attention network (GAT) to form a fused point cloud having fused features.

### TECHNICAL FIELD

This disclosure relates to objection detection and object segmentation using three-dimensional (3D) data.

### BACKGROUND

Three-dimensional (3D) semantic object segmentation and detection may include identifying and delineating individual objects within three-dimensional data, such as that obtained from Light Detection and Ranging (LiDAR) systems and/or imaging systems. Unlike two-dimensional (2D) image segmentation, where objects are segmented on a planar image, 3D segmentation operates on volumetric data, enabling a better understanding of objects in a spatial context. Semantic segmentation means that each segmented object is not only detected but also classified into predefined categories. This technology has applications in fields like autonomous driving, advanced driver-assistance systems (ADAS), robotics, and extended reality (XR) systems, where understanding and interpreting the 3D environment is beneficial.

### SUMMARY

The present disclosure generally relates to 3D semantic segmentation and objection detection techniques that use data obtained from both a 3D sensor, such as a LiDAR system, and a 2D sensor, such as one or more cameras. In particular, this disclosure describes techniques where features from a point cloud captured by a LiDAR system are fused with features in a plurality of camera images. Rather than fusing features from the LiDAR system and the plurality of cameras in a 2D plane, such as in a bird's eye view (BEV) image, this disclosure describes techniques where the features of the point cloud and the features of the plurality of camera images are fused at the voxel-level in a 3D graph representation.

In one example, camera features may be detected in a plurality of camera images. These camera images may be transformed into a 3D voxel grid, e.g., using depth data from a corresponding point cloud. A graph representation of the 3D voxel grid is formed, the graph representation having the camera features. In addition, a corresponding point cloud may be voxelized, and another graph representation may be generated from the voxelized point cloud. The two graph representations from the point cloud and the plurality of camera images may be merged into a joint graph representation having point cloud features and camera features from both the point cloud and the camera images, respectively.

This joint graph representation may then be processed by a graph neural network (GNN) to further enhance the point cloud and camera features. A diffusion process may then be performed enhanced graph representation in order to denoise the features. The denoised features may then be fused using a graph attention network (GAT). These fused features may be processed by a fully connected layer (e.g., as the last layer of the GAT) to produce a fused point cloud that may be used for 3D semantic segmentation and/or object detection purposes.

The GNNs and GATs of this disclosure are specifically designed to model the interactions between the features of neighboring nodes in a graph. By treating the 3D voxel space of both the point cloud and the plurality of camera images as a graph and the voxels as nodes, the techniques of this disclosure can leverage the capabilities of GNNs and GATs to learn a representation of each voxel that incorporates information from its neighboring voxels. Such techniques may better capture the complex spatial relationships and dependencies between the point cloud and camera features, resulting in more effective feature fusion and better performance in 3D semantic segmentation and 3D object detection.

In one example, this disclosure describes an apparatus for processing image data and point cloud data, the apparatus comprising a memory, and processing circuitry in communication with the memory, wherein the processing circuitry is configured to process a joint graph representation using a GNN to form an enhanced graph representation, wherein the joint graph representation includes first features from a voxelized point cloud, and second features from a plurality of camera images, and wherein the enhanced graph representation includes enhanced first features and enhanced second features, perform a diffusion processes on the enhanced first features and the enhanced second features of the enhanced graph representation to form a denoised graph representation having denoised first features and denoised second features, fuse the denoised first features and the denoised second features of the denoised graph representation using a GAT to form a fused point cloud having fused features, and perform a 3D image segmentation process on the fused point cloud.

In another example, this disclosure describes a method for processing image data and point cloud data, the method comprising processing a joint graph representation using a GNN to form an enhanced graph representation, wherein the joint graph representation includes first features from a voxelized point cloud, and second features from a plurality of camera images, and wherein the enhanced graph representation includes enhanced first features and enhanced second features, performing a diffusion processes on the enhanced first features and the enhanced second features of the enhanced graph representation to form a denoised graph representation having denoised first features and denoised second features, fusing the denoised first features and the denoised second features of the denoised graph representation using a GAT to form a fused point cloud having fused features, and performing a 3D image segmentation process on the fused point cloud.

In another example, this disclosure describes an apparatus for processing image data and point cloud data, the apparatus comprising means for processing a joint graph representation using a GNN to form an enhanced graph representation, wherein the joint graph representation includes first features from a voxelized point cloud, and second features from a plurality of camera images, and wherein the enhanced graph representation includes enhanced first features and enhanced second features, means for performing a diffusion processes on the enhanced first features and the enhanced second features of the enhanced graph representation to form a denoised graph representation having denoised first features and denoised second features, means for fusing the denoised first features and the denoised second features of the denoised graph representation using a GAT to form a fused point cloud having fused features, and means for performing a 3D image segmentation process on the fused point cloud.

In another example, this disclosure describes a non-transitory computer-readable storage medium storing instructions that, when executed, causes one or more processors of a device configured to process image data and point cloud data to process a joint graph representation using a GNN to form an enhanced graph representation, wherein the joint graph representation includes first features from a voxelized point cloud, and second features from a plurality of camera images, and wherein the enhanced graph representation includes enhanced first features and enhanced second features, perform a diffusion processes on the enhanced first features and the enhanced second features of the enhanced graph representation to form a denoised graph representation having denoised first features and denoised second features, fuse the denoised first features and the denoised second features of the denoised graph representation using a GAT to form a fused point cloud having fused features, and perform a 3D image segmentation process on the fused point cloud.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with the techniques of this disclosure.

FIG. 2 is a block diagram illustrating one example of voxel-level fusion in accordance with the techniques of this disclosure.

FIG. 3 is a block diagram illustrating one example of 3D transformation for a plurality of camera images in accordance with the techniques of this disclosure.

FIG. 4 is a flow diagram illustrating an example process for voxel-level fusion in accordance with the techniques of this disclosure.

### DETAILED DESCRIPTION

Camera and Light Detection and Ranging (LiDAR) systems may be used together in various different robotic, automotive, extended reality (XR), and virtual reality (VR) applications. One such automotive application is an advanced driver assistance system (ADAS). ADAS is a system that utilizes both camera and LiDAR sensor technology to improve driving safety, comfort, and overall vehicle performance. This system combines the strengths of both sensors to provide a more comprehensive view of a vehicle's surroundings, enabling the ADAS to better assist the driver in various driving scenarios.

In some examples, the camera-based system is responsible for capturing high-resolution images and processing them in real time. The output images of such a camera-based system may be used in applications such as depth estimation, object detection, image segmentation, and/or pose detection, including the detection and recognition of objects, such as other vehicles, pedestrians, traffic signs, and lane markings. Cameras may be particularly good at capturing color and texture information, which is useful for accurate object recognition and classification.

LiDAR sensors emit laser pulses to measure the distance, shape, and relative speed of objects around the vehicle. LiDAR sensors provide three-dimensional (3D) data (e.g., a point cloud), enabling the ADAS to create a detailed map of the surrounding environment. LiDAR may be particularly effective in low-light or adverse weather conditions, where camera performance may be hindered. In some examples, the output of a LiDAR sensor may be used as partial ground truth data for performing neural network-based depth information on corresponding camera images.

By fusing the data gathered from both camera and LiDAR sensors, an ADAS or another kind of system can deliver enhanced situational awareness and improved decision-making capabilities. This enables various driver assistance features such as adaptive cruise control, lane keeping assist, pedestrian detection, automatic emergency braking, and parking assistance. The combined system can also contribute to the development of semi-autonomous and fully autonomous driving technologies, which may lead to a safer and more efficient driving experience.

Some example techniques for 3D semantic segmentation and 3D object detection have focused on using a 2D Bird's Eye View (BEV) representation, as downstream tasks like tracking and prediction benefit this representation. However, the output bounding box representation for 3D object detection techniques is a 3D representation. Converting a plurality of camera images to a 2D BEV space results in a considerable amount of ambiguity as the 2D BEV representation is a novel view altogether compared to a LiDAR point, which is flattened in the BEV representation (e.g., the z-axis of the point cloud is flattened). The native representation of a LiDAR point cloud is in 3D. It would be beneficial to leverage all point cloud features, rather than omitting the ‘z’ values and splatting the features onto a BEV grid directly.

In view of these drawbacks, this disclosure describes techniques where features from a point cloud captured by a LiDAR system are fused with features in a plurality of camera images. Rather than fusing features from the LiDAR system and the plurality of cameras in a 2D plane, such as in BEV representation, this disclosure describes techniques where the features of the point cloud and the features of the plurality of camera images are fused at the voxel-level in a 3D graph representation.

In one example, camera features may be detected in a plurality of camera images. These camera images may be transformed into a 3D voxel grid, e.g., using depth data from a corresponding point cloud. A graph representation of the 3D voxel grid is formed, the graph representation having the camera features. In addition, a corresponding point cloud may be voxelized, and another graph representation may be generated from the voxelized point cloud. The two graph representations from the point cloud and the plurality of camera images may be merged into a joint graph representation having point cloud features and camera features from both the point cloud and the camera images, respectively. This joint graph representation may then be processed by a graph neural network (GNN) to further enhance the point cloud and camera features.

The point cloud features are sparse and the camera features transformed to the 3D voxel grid representation space are only dense in the near-by regions. To enhance the features in the 3D space we propose to use further perform a diffusion process on the enhanced graph representation in order to denoise the features. Diffusion can be used to improve the fusion of point cloud and camera features in a voxel 3D space for 3D object detection. Diffusion is a process of smoothing and spreading out information in a given space, and it can be used to enhance the representation of sparse features in a 3D space.

The denoised features may then be fused using a graph attention network (GAT). The diffusion process described above propagates information between adjacent voxels in the 3D space, while the GAT selectively focuses on certain regions of the space to fuse the features. These fused features may be processed by a fully connected layer (e.g., as the last layer of the GAT) to produce a fused point cloud that may be used for 3D semantic segmentation and/or object detection purposes

In some examples of 3D object detection, point cloud and camera image features are typically processed separately, and their respective feature maps are generated. However, the fusion of these feature maps using traditional methods, such as concatenation or element-wise addition, may not fully capture the complex spatial relationships between the features of neighboring voxels in the 3D voxel space.

The GNNs and GATs of this disclosure are specifically designed to model the interactions between the features of neighboring nodes in a graph. By treating the 3D voxel space of both the point cloud and the plurality of camera images as a graph and the voxels as nodes, the techniques of this disclosure can leverage the capabilities of GNNs and GATs to learn a representation of each voxel that incorporates information from its neighboring voxels. Such techniques may better capture the complex spatial relationships and dependencies between the point cloud and camera features, resulting in more effective feature fusion and better performance in 3D semantic segmentation and 3D object detection.

In one example, this disclosure describes an apparatus for processing image data and point cloud data, the apparatus comprising a memory, and processing circuitry in communication with the memory, wherein the processing circuitry is configured to process a joint graph representation using a GNN to form an enhanced graph representation, wherein the joint graph representation includes first features from a voxelized point cloud, and second features from a plurality of camera images, and wherein the enhanced graph representation includes enhanced first features and enhanced second features. The processing circuitry may perform a diffusion processes on the enhanced first features and the enhanced second features of the enhanced graph representation to form a denoised graph representation having denoised first features and denoised second features, and fuse the denoised first features and the denoised second features of the denoised graph representation using a GAT to form a fused point cloud having fused features. The processing circuitry may then perform a 3D image segmentation process on the fused point cloud.

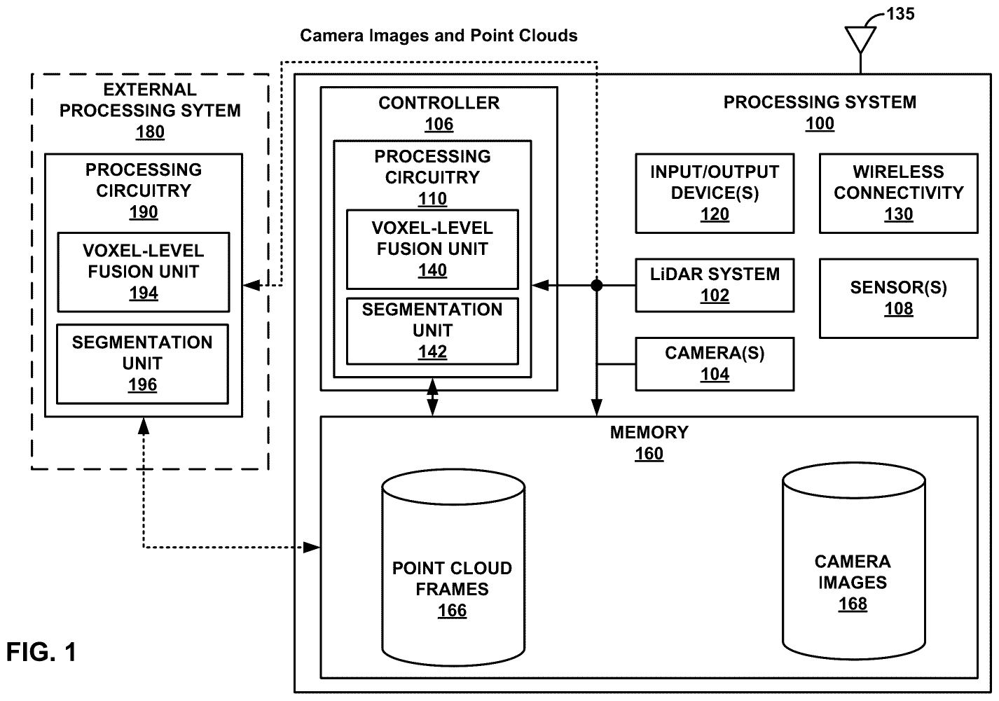

FIG. 1 is a block diagram illustrating an example processing system 100, in accordance with one to more techniques of this disclosure. Processing system 100 may be used in a vehicle, such as an autonomous driving vehicle or an assisted driving vehicle (e.g., a vehicle having an advanced driver-assistance systems (ADAS) or an “ego vehicle”). In such an example, processing system 100 may represent an ADAS. In other examples, processing system 100 may be used in robotic applications, virtual reality (VR) applications, extended reality (XR), or other kinds of applications that may include, or have access to data from, both a camera and a LiDAR system. The techniques of this disclosure for voxel-level feature fusion are not limited to vehicular applications. The techniques of this disclosure may be applied by any system that processes image data and/or position data, such as point clouds.

Processing system 100 may include LiDAR system 102, camera(s) 104, controller 106, one or more sensor(s) 108, input/output device(s) 120, wireless connectivity component 130, and memory 160. LiDAR system 102 may include one or more light emitters (e.g., lasers) and one or more light sensors. LiDAR system 102 may, in some cases, be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 is not limited to being deployed in or about a vehicle. LiDAR system 102 may be deployed in or about another kind of object.

In some examples, the one or more light emitters of LiDAR system 102 may emit such pulses in a 360-degree field around the vehicle so as to detect objects within the 360-degree field by detecting reflected pulses using the one or more light sensors. For example, LiDAR system 102 may detect objects in front of, behind, or beside LiDAR system 102. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. LiDAR processing circuitry of LiDAR system 102 may generate one or more point cloud frames mased on the one or more optical signals emitted by the one or more light emitters of LiDAR system 102 and the one or more reflected optical signals sensed by the one or more light sensors of LiDAR system 102. These points are generated by measuring the time it takes for a laser pulse to travel from a light emitter to an object and back to a light detector. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization: Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. Cameras used to capture color information for point cloud data may, in some examples, be separate from camera(s) 104. The color attribute includes color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class (e.g., a feature) based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera(s) 104 may be any type of camera configured to capture video or image data in the environment around processing system 100 (e.g., around a vehicle). In some examples, processing system 100 may include multiple cameras 104. For example, camera(s) 104 may include a front facing camera (e.g., a front bumper camera, a front windshield camera, and/or a dashcam), a back facing camera (e.g., a backup camera), side facing cameras (e.g., cameras mounted in sideview mirrors). Camera(s) 104 may be a color camera or a grayscale camera. In some examples, camera(s) 104 may be a camera system including more than one camera sensor. While techniques of this disclosure will be described with reference to a 2D photographic camera, the techniques of this disclosure may be applied to the outputs of other sensors including an infrared camera and/or a time-of-flight (ToF) camera.

LiDAR system 102 may, in some examples, be configured to collect point cloud frames 166. Camera(s) 104 may be configured to collect camera images 168. An importance of data input modalities, such as point cloud frames 166 and camera images 168, may vary for indicating one or more characteristics or features of objects in a 3D environment. For example, when color and texture are important characteristics of a first object and when color and texture are not important characteristics of a second object, camera images 168 may be more important for identifying characteristics of the first object as compared with the importance of camera images 168 for identifying characteristics of the second object. Since both pint cloud frames 166 and camera images 168 may be important for detecting and identifying different types of objects, it may be beneficial to combine the features of both point clouds and camera images when performing 3D semantic image segmentation. The techniques of this disclosure, as will be described in more detail below, may further improve the fusion of features from point clouds and camera images.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processing circuitry 110. Controller 106 is not limited to controlling vehicles. Controller 106 may additionally or alternatively control any kind of controllable object, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure. In some examples, one or more of processing circuitry 110 may be based on an Advanced Reduced Instruction Set Computer (RISC) Machine (ARM) or a RISC five (RISC-V) instruction set.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with LiDAR system 102, camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

In accordance with the techniques of this disclosure processing system 100 may be configured to perform techniques for extracting features from image data and position data and fusing the features on a voxel level for further use in 3D semantic segmentation and object detection. For example, processing circuitry 110 may include voxel-level fusion unit 140 configured to perform the fusion techniques of this disclosure.

Segmentation unit 142 may be configured to perform one or more 3D semantic segmentation and/or object detection processes on the fused features produced by voxel-level fusion unit 140. Voxel-level fusion unit 140 and segmentation unit 142 may be implemented in software, firmware, and/or any combination of hardware described herein.

As described above, some example techniques for 3D semantic segmentation and 3D object detection have focused on using a 2D BEV representation, as downstream tasks like tracking and prediction benefit this representation. However, the output bounding box representation for 3D object detection techniques is a 3D representation. Converting a plurality of camera images to a 2D BEV space results in a considerable amount of ambiguity since the 2D BEV representation is a novel view altogether compared to a LiDAR point, which is flattened in the BEV representation (e.g., the z-axis of the point cloud is flattened). The native representation of a LiDAR point cloud is in 3D. It would be beneficial to leverage all point cloud features, rather than omitting the ‘z’ values and splatting the features onto a BEV grid directly.

In view of these drawbacks, voxel-level fusion unit 140 may be configured to fuse features from a point cloud (e.g., from point cloud frame 166) captured by LiDAR system 102 with features in a plurality of camera images (e.g., camera images 168) captured by camera(s) 104. Rather than fusing features from LiDAR system 102 and camera(s) 104 in a 2D plane, such as in BEV representation, voxel-level fusion unit 140 is configured to fuse the features of a point cloud and the features of the plurality of camera images at the voxel-level in a 3D graph representation.

In one example, voxel-level fusion unit 140 is configured to detect camera features in a plurality of camera images (e.g., camera images 168). The plurality of camera images may be captured by multiple different cameras of camera(s) 104 at the same time, but at different fields of view. Voxel-level fusion unit 140 may transform the camera images into a 3D voxel grid, e.g., using depth data from a corresponding point cloud (e.g., a point cloud captured at approximately the same time as the camera images).

Voxel-level fusion unit 140 may form a graph representation of the 3D voxel grid, where the graph representation includes the camera features. In addition, voxel-level fusion unit 140 may voxelize the corresponding point cloud (e.g., from point cloud frames 166), and may generate another graph representation from the voxelized point cloud. Voxel-level fusion unit 140 may then merge the two graph representations from the point cloud and the plurality of camera images into a joint graph representation having point cloud features and camera features from both the point cloud and the camera images, respectively. Voxel-level fusion unit 140 may then process this joint graph representation using a graph neural network (GNN) to further enhance the point cloud and camera features.

In general, point cloud features are sparse and the camera features transformed to the 3D voxel grid representation space are typically only dense in the near-by regions (e.g., regions near to the camera). To enhance the features in the 3D space, voxel-level fusion unit 140 may be further configured to perform a diffusion process on the enhanced graph representation in order to denoise the features. Diffusion can be used to improve the fusion of point cloud and camera features in a voxel 3D space for 3D object detection. Diffusion is a process of smoothing and spreading out information in a given space, and can be used to enhance the representation of sparse features in a 3D space.

Voxel-level fusion unit 140 may then fuse the denoised features a graph attention network (GAT). The diffusion process described above propagates information between adjacent voxels in the 3D space, while the GAT selectively focuses on certain regions of the space to fuse the features. These fused features may be processed by a fully connected layer (e.g., as the last layer of the GAT) to produce a fused point cloud. Segmentation unit 142 may then use the fused point cloud for 3D semantic segmentation and/or object detection purposes.

In some examples of 3D object detection, point cloud and camera image features are typically processed separately, and their respective feature maps are generated. However, the fusion of these feature maps using traditional methods, such as concatenation or element-wise addition, may not fully capture the complex spatial relationships between the features of neighboring voxels in the 3D voxel space.

The GNNs and GATs implemented by voxel-level fusion unit 140 are specifically designed to model the interactions between the features of neighboring nodes in a graph. By treating the 3D voxel space of both the point cloud and the plurality of camera images as a graph and the voxels as nodes, the techniques of this disclosure can leverage the capabilities of GNNs and GATs to learn a representation of each voxel that incorporates information from its neighboring voxels. Such techniques may better capture the complex spatial relationships and dependencies between the point cloud and camera features, resulting in more effective feature fusion and better performance in 3D semantic segmentation and 3D object detection.

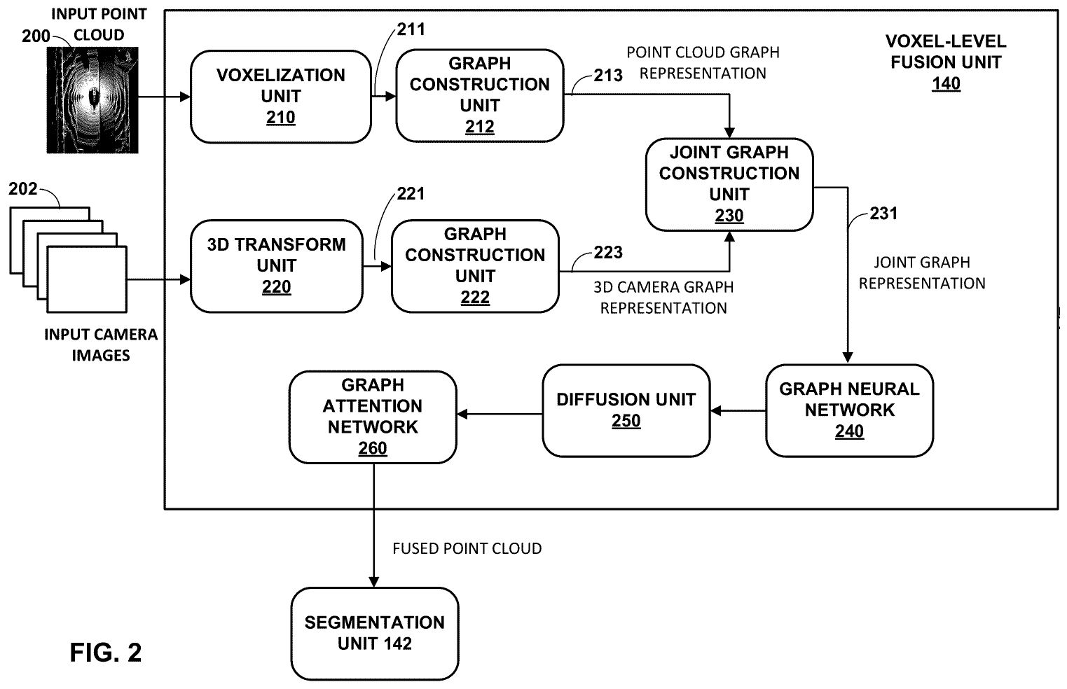

In a general example of the disclosure, which will be described in more detail below with reference to FIG. 2, voxel-level fusion unit 140 may be configured to process a joint graph representation using a GNN to form an enhanced graph representation. The joint graph representation includes first features from a voxelized point cloud, and second features from a plurality of camera images. The enhanced graph representation includes enhanced first features and enhanced second features. Voxel-level fusion unit 140 may perform a diffusion processes on the enhanced first features and the enhanced second features of the enhanced graph representation to form a denoised graph representation having denoised first features and denoised second features. Voxel-level fusion unit 140 may fuse the denoised first features and the denoised second features of the denoised graph representation using a GAT to form a fused point cloud having fused features. Segmentation unit 142 may then perform a 3D image segmentation process on the fused point cloud. Examples of 3D image segmentation process may include one or more of object detection, object classification, thresholding segmentation, region-based segmentation, edge-based segmentation, clustering-based segmentation, semantic segmentation, or instance segmentation.

The techniques of this disclosure may also be performed by external processing system 180. That is, the voxel-level feature fusion techniques of this disclosure may be performed by a processing system that does not include the various sensors shown for processing system 100. Such a process may be referred to as “offline” data processing, where the output is determined from a set of point clouds and images received from processing system 100. External processing system 180 may send an output to processing system 100 (e.g., an ADAS or vehicle).

External processing system 180 may include processing circuitry 190, which may be any of the types of processors described above for processing circuitry 110. Processing circuitry 190 may include voxel-level fusion unit 194 that is configured to perform the same processes as voxel-level fusion unit 140. Processing circuitry 190 may further include segmentation unit 196 that is configured to perform the same processes as segmentation unit 142. Processing circuitry 190 may acquire point cloud frames 166 and camera images 168 directly from LiDAR system 102 and camera(s) 104, respectively, or from memory 160. Though not shown, external processing system 180 may also include a memory that may be configured to store point cloud frames and camera images, among other data that may be used in data processing.

FIG. 2 is a block diagram illustrating one example of voxel-level fusion in accordance with the techniques of this disclosure. As shown in FIG. 2, voxel-level fusion unit 140 receives input point cloud 200 and input camera images 202 (e.g., a plurality of camera images). Input point cloud 200 may be one of point cloud frames 166 of FIG. 1. Input camera images 202 may be a plurality of camera images 168 of FIG. 1 that were captured at the same time by camera(s) 104, but at different fields of view. That is, each of input camera images 202 may have been captured by a different camera having different fields of view. Input point cloud 200 may have been captured at substantially the same time as input camera images 202. The techniques of FIG. 2 are described with reference to point clouds and camera images captured at one point in time. However, the techniques of FIG. 2 may be performed continuously for each set of input data at the image capture rate of the system.

3D transform unit 220 is generally configured to transform input camera images 202 into 3D voxel grid 221. In this context, 3D voxel grid 221 is a 3D volume of data divided into a grid of voxels. The term voxel is derived from the words “volume” and “pixel.” A voxel represents a value on a regular grid in 3D space, similar to how a pixel represents a value on a regular grid in 2D space. A voxel is the smallest distinguishable box-shaped part of a three-dimensional space. Just as an image is made up of a grid of pixels, a 3D volume can be thought of as being made up of a stack or grid of voxels. Each voxel may include one or more values (e.g., points or features) which might signify various things depending on the context.

3D transform unit 220 may determine camera features from input camera images 202, e.g., using an image segmentation encoder. In the context of an image segmentation encoder, a “feature” generally refers to a representation learned from the input image that captures certain patterns or characteristics of objects found in the image. These features are used to make decisions, such as segmenting the image into different regions. 3D transform unit 220 may also determine depth estimates for the features in the input images 202.

3D transform unit 220 may project the features of the input camera images 202 onto 2D plane to form projected features, and then perform a geometric transformation, based on the depth estimates, to map the second features into 3D voxel grid 221. For example, 3D transform unit 220 may perform a BEV projection that projects input camera images 202 onto a 2D plane. 3D transform unit 220 then transforms the 2D BEV image into 3D voxel grid 221 using a geometric transformation. In one example, this transformation maps the 2D BEV image obtained to 3D voxel grid 221 by associating each pixel in the image with a voxel in the 3D grid. The height of each voxel in the grid is determined based on the distance of the corresponding point in the 2D image from the camera.

In some examples, the transformation is based on a based on a Lift Splat Shoot (LSS) approach. In the context of BEV images, LSS is a pipeline for processing point cloud data. “Lift” involves lifting 2D points to a 3D space. “Splat” refers to rasterizing or projecting these 3D points back onto a 2D grid. “Shoot” usually involves using the rasterized grid to make a decision or perform an action, such as classification or object detection. This sequence allows for efficient and effective handling of point cloud data for various applications.

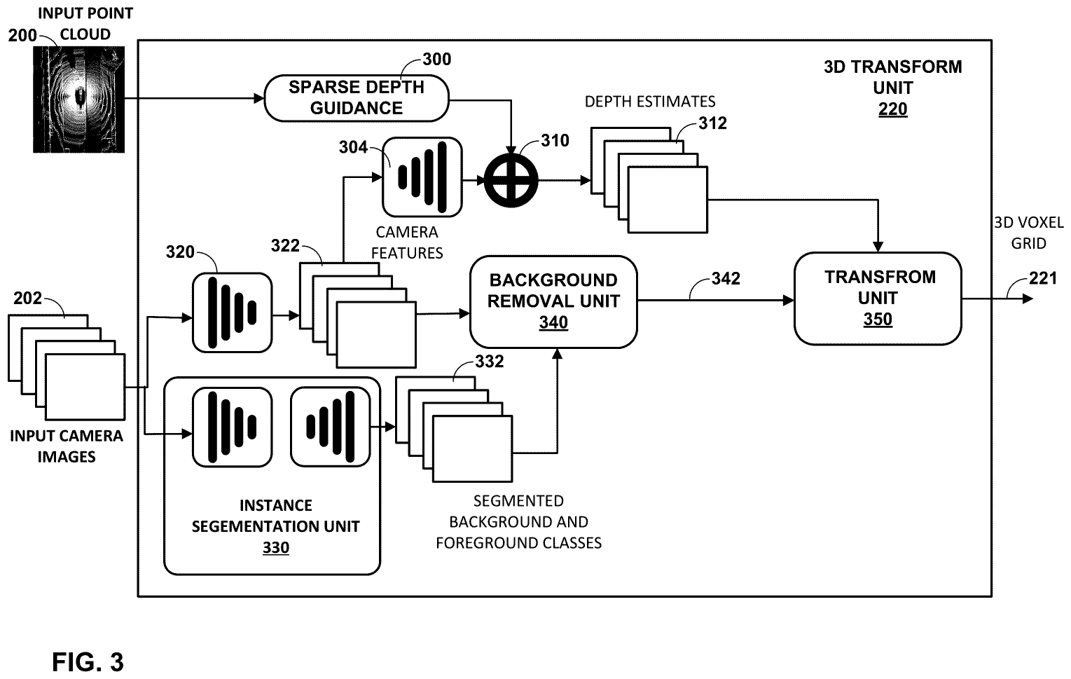

Further details on the operation of 3D transform unit 220, including the use of depth supervision from input point cloud 200 and background removal, will be described below with reference to FIGS. 3-6.

Graph construction unit 222 takes 3D voxel grid 221 generated by 3D transform unit 220 as input. 3D voxel grid 221 includes features of input camera images 202. Graph construction unit 222 generates 3D camera graph representation 223 of 3D voxel grid 221.

In the context of computer vision, a 3D image or a point cloud can be represented as a graph (e.g., a graph representation) where each node represents a voxel in the 3D space, and edges connect nearby or related voxels based on certain criteria. The graph can encapsulate spatial relationships, attributes, or features corresponding to each voxel or connection. In examples of the disclosure, each node (e.g., voxel) of the graph may have attributes that include the features detected for each corresponding voxel.

In one example, a node may be represented by coordinates, colors, attributes, and other features. Coordinates for each node can be labeled with the (x, y, z) coordinates of a voxel in the 3D space. If color information is available (e.g., RGB), this color information can also be included as attributes of each node, in addition the detected features discussed above. Other features may also be associated with a node, including normals, curvatures, and other geometric or topological features.

The graph representation may also be defined by edges. An edge representation may be in the form of one or more of a Euclidean distance, k-nearest neighbors, graph density, feature similarity, or visibility. For example, an edge could represent the Euclidean distance between two voxels. In other examples, edges can be formed between a voxel and its k-nearest neighbors.

In some examples, edges can be added to maintain a certain graph density.

Additionally, edges can be weighted based on feature similarity in attributes, such as color, normal direction, semantic features, etc. In still other examples, edges can connect points that are visible to each other, which may be useful tasks that involve the reconstruction of surfaces.

Graph construction unit 222 generates 3D camera graph representation 223 from 3D voxel grid 221. 3D camera graph representation 223 includes the features detected in input camera images 202 as attributes of each node of the graph, where the nodes of the graph correspond with the voxels of 3D voxel grid 221. As will discussed in more detail below, 3D camera graph representation 223 may be combined with point cloud graph representation 213 to form joint graph representation 231 that includes features from both input point cloud 200 and input camera images 202 (e.g., features from both point cloud graph representation 213 and 3D camera graph representation 223).

To obtain the features of the input point cloud 200 in the voxel space, voxelization unit 210 may be configured to voxelize input point cloud 200 to generate voxelized point cloud 211. In this example, voxelization is a process of converting a point cloud into a 3D grid structure (e.g., voxelized point cloud 211) composed of discrete volume elements known as voxels, as described above.

The voxelization process essentially discretizes the 3D space of input point cloud 200 into a regular grid, then fills the grid cells (voxels) with information based on the properties of the points that fall into each cell. The occupancy or density of points within the voxel are used as features. As such, voxelization unit 210 produces voxelized point cloud 211 from input point cloud 200, wherein voxelized point cloud 211 includes features of input point cloud 200. Below is a general outline of how a point cloud may voxelized.

First voxelization unit 210 defines the grid space and determines the resolution of the voxel grid, which essentially determines the dimensions of each voxel. This grid will span the range of the point cloud in all three dimensions (x, y, z). Voxelization unit 210 may be configured to voxelize input point cloud 200 into same number of voxels, and same size/resolution of voxels, that are in 3D voxel grid 221 produced by 3D transform unit 220.

Voxelization unit 210 may then create an empty 3D array or data structure to represent the grid. Each cell in the array corresponds to a voxel in the 3D grid and starts as empty or unoccupied. For each point in the point cloud, voxelization unit 210 identifies which voxel the point falls into based on its (x, y, z) coordinates. This process may involve dividing the coordinate value by the voxel dimension and taking the integer part.

Once a point has been mapped to a voxel, voxelization unit 210 may fill that voxel with some information, such as features of the point. In this context, the features may include binary occupancy, point count, or an average. For binary occupancy, a voxel is marked as occupied if at least one point maps to the voxel. Point count refers to the number of points and/or features in the voxel. In some examples, information indicating an average of all points' attributes that map to the voxel.

Graph construction unit 212 may then construct point cloud graph representation 213 from voxelized point cloud 211 using the same techniques of graph construction unit 222, as described above. For example, graph construction unit 212 constructs a graph representation of the 3D voxel space, where each voxel is defined as a node in the graph. Graph construction unit 212 connects each node to its neighboring nodes in the 3D space to form edges. As such, the graph G may be represented as G=(V, E), where V is the set of nodes representing the voxels, and E is the set of edges connecting the voxels.

Joint graph construction unit 230 may take point cloud graph representation 213 and the 3D camera graph representation 223 as inputs. As discussed above, the nodes of each of the graph representations represent the same size voxel from the same volume of a 3D voxel grid. That is, each corresponding node in each graph representation represents the same position in 3D space. As such, joint graph construction unit may output a single joint graph representation, where each node of joint graph representation 231 has attributes with features from input camera images 202 and features from input point cloud 200. The attributes of the node of joint graph representation 231 may store these two sets of features separately. That is, joint graph construction unit 230 may associate the features from 3D camera graph representation 223 and the features of point cloud graph representation 213 with the nodes of joint graph representation 231.

As will be discussed below, graph neural network (GNN) 240, diffusion unit 250, and graph attention network (GAT) 260 are configured to fuse the camera LiDAR features to generate fused point cloud having a single set of fused features. In the context of 3D semantic image segmentation and/or 3D object detection, GNN 240 may be configured to to learn the relationship between the voxels of joint graph representation 231 and fuse the features extracted from input point cloud 200 and input camera images 202.

GNNs are a class of deep learning models designed to process data structured as graphs. As discussed above, graphs are mathematical structures that consist of nodes (or vertices) and edges connecting these nodes. Nodes typically represent entities (in this case, voxels), and edges represent relationships or interactions between entities.

One main part of a GNN is a message-passing or propagation mechanism. During processing by each layer of the network, every node aggregates information from its neighbors and possibly itself. This aggregation is typically done using functions like summation or averaging. After aggregation, the GNN updates the representation of a node by combining the aggregated information with the current representation of the node using a non-linear transformation (e.g., a neural network layer followed by an activation function).

The propagation and update process can be done recursively for several layers, allowing nodes to gather information from a larger and larger neighborhood at each subsequent layer. After several layers of propagation and update, the nodes' representations can be pooled together to get a graph-level representation. This can be done through various mechanisms, such as averaging or using more sophisticated pooling strategies.

GNN 240 takes the voxel features as input and applies a series of graph convolutional operations to learn a set of enhanced voxel (e.g., node) features. GNN 240 enhances the voxel features by aggregating information from different parts of the voxel feature space. As a result, GNN 240 does not process just the local arrangement of voxel features, but also processes the global arrangement of the voxel feature space, where weightings of more distant features are typically less than weightings on closer features. This global processing leads to better object detection. GNN 240 takes the graph G (e.g., the joint graph representation) and the initial node attributes X_0 (including the point cloud and camera image features of each voxel) as input and produces an updated node feature representation X_1 for each layer l of GNN 240. Each layer of the GNN includes a message passing step, followed by an update step.

hᵢ^{(l)}=Σ_{j∈N(i)}f(hᵢ^{(l-1)},hⱼ^{(l-1)}) Message Passing:

hᵢ^{(l)}=g(hᵢ^{(l)},hᵢ^{(l-1)}) Update:

In the above, hᵢ^{(l)} is the feature representation of voxel i at layer l of GNN 240. N(i) is the set of neighbors of voxel i. The function f is a learnable message function that takes the features of voxel i and its neighbors as input and produces a message for each neighbor. The function g is a learnable update function that takes the current feature representation of voxel i and its previous representation as input and produces a new representation.

To further enhance the voxel features, diffusion unit 250 may perform a diffusion process on the previously obtained enhanced features in the enhanced graph representation produced by GNN 240. The diffusion process performed by diffusion unit 250 spreads the information from neighboring voxels to further enhance and denoise the feature of each voxel. The diffusion process is formulated using a diffusion kernel to the feature map, which is a function that determines how the features are propagated between voxels. A common diffusion kernel is the Gaussian kernel, which is defined as:

K(x,y)=1/2πσ² exp(−∥x−y∥²/2σ²)

In the above, x and y are the positions of two voxels in the 3D space, ∥x−y∥ is the Euclidean distance between them, and σ is a parameter that controls the spread of the kernel. Diffusion unit 250 convolves the diffusion kernel with the feature map obtained from the GNN 240 to obtain the diffused feature map (e.g., a denoised graph representation) using a discrete convolution operator, as shown below.

f′(i,j,k)=Σ_{x,y,z}f(x,y,z)·K(i−x,j−y,k−z)

In the above, f(x, y, z) is the feature value at voxel (x, y, z), f′(i, j, k) is the diffused feature value at voxel (i, j, k), and the sum is taken over all voxels in the 3D space that are within a certain distance from voxel (i, j, k).

After the voxel feature diffusion process, the denoised graph representation is input to GAT 260 further refinement and fusion. A GAT is a type of neural network layer that operates on graph-structured data. In the examples of this disclosure, the point cloud and camera image voxel features can be represented as a graph where each voxel is a node and the edges represent the relationships between the voxels. GAT 260 may be configured to assign weights to the edges based on the features of the nodes they connect and use these weights to aggregate information from the neighboring nodes to refine and fuse the features of each node.

In general, a GAT is a type of GNN that use attention mechanisms to weigh the importance of neighboring nodes differently when aggregating information. Traditional GNNs often treat neighboring nodes equally or rely on predefined weights, but GATs introduce a self-attention mechanism, enabling nodes to emphasize certain neighbors over others based on their feature information.

GAT 260 may employ a shared self-attention mechanism to weigh the importance of each neighbor node's features. This means that for each node, GAT 260 determines the importance of its neighbors' features dynamically based on both the node's and the neighbors' current feature states. After determining attention weights, GAT 260 may aggregates feature information from neighboring nodes based on these weights. The higher the attention weight, the more influence a neighbor's features have on the current node. The aggregated feature from neighbors are then combined with the node's own feature, often followed by a non-linear transformation like the ReLU activation function.

Let X be the input feature matrix to GAT 260 of shape (N, F), where N is the number of nodes (e.g., voxels) in the graph, and F is the number of features per node. A layer for GAT 260 learns a weight matrix, W, of shape (F′, F), where F′ is the number of output features per node, and a weight matrix, A, of shape (N, N), which represents the adjacency matrix of the graph. The output of the GAT layer, H, is given by:

H=softmax((D^{-1/2})×A×(D^{-1/2})×X×W).

where D is the diagonal degree matrix of the graph, defined as D(i,i)=Σⱼ₋₁ⁿA(i,j) and softmax is the activation function that ensures that the output values are between 0 and 1 and sum up to 1.

The first term (D^{-1/2})×A×(D^{-1/2}) represents the graph attention mechanism, which computes a weighted average of the features of the neighboring nodes for each node in the graph. The second term X*W is a linear transformation of the input features to a new feature space.

Layers of GAT 260 are stacked to learn more complex representations of the graph. The output of the last GAT layer is passed through a fully connected layer to obtain the final output for the 3D object detection task (e.g., the fused point cloud). A fully connected layer is a type of neural network layer where each neuron (or node) is connected to every neuron in the previous layer and every neuron in the following layer. This is in contrast to convolutional layers in which neurons are only connected to a small, localized region of the previous layer.

Since every neuron in a fully connected layer is connected to all neurons in the previous layer, there is a weight associated with each connection. Additionally, each neuron in the fully connected layer has a bias term. These weights and biases are the learnable parameters of the layer. The output of each neuron in a fully connected layer is the weighted sum of all inputs to that neuron (from the neurons in the previous layer) plus its bias. This sum is then typically passed through an activation function, such as the sigmoid, ReLU, or tanh function. In many deep learning architectures the final layers are often fully connected layers that produce the output probabilities for each class in a classification task. The fused point cloud output from GAT 260 may include fused features (e.g., class predictions) and information indicating bounding boxes around the fused features. In summary, GAT 260 may fuse the denoised first features and the denoised second features of the denoised graph representation using the one or more attention layers of GAT 260 to generate a fused graph representation, and may process the fused graph representation using the fully connected layer to generate the fused point cloud having the fused features.

In summary, voxel-level fusion unit 140 may be configured to process a joint graph representation (e.g., generated by joint graph construction unit 230) using GNN 240 to form an enhanced graph representation. The joint graph representation includes first features from a voxelized point cloud, and second features from a plurality of camera images. The enhanced graph representation includes enhanced first features and enhanced second features. Diffusion unit 250 of voxel-level fusion unit 140 may perform a diffusion processes on the enhanced first features and the enhanced second features of the enhanced graph representation to form a denoised graph representation having denoised first features and denoised second features. GAT 260 of voxel-level fusion unit 140 may fuse the denoised first features and the denoised second features of the denoised graph representation using a GAT to form a fused point cloud having fused features. Segmentation unit 142 may then perform a 3D image segmentation process on the fused point cloud. Examples of 3D image segmentation process may include one or more of object detection, object classification, thresholding segmentation, region-based segmentation, edge-based segmentation, clustering-based segmentation, semantic segmentation, or instance segmentation.

The techniques of this disclosure may provide for improved feature representation and more effective feature fusion. The diffusion process helps to enhance the voxel features by spreading the information across the 3D space. This results in a more comprehensive representation of the input data, which can improve the accuracy of the image segmentation and object detection process. Additionally, by fusing the point cloud and camera image data in the 3D voxel space, the techniques of this disclosure may capture the unique advantages of both modalities. The graph neural networks with attention-based refinement can effectively combine these features to improve the accuracy of the object detection.

FIG. 3 is a block diagram illustrating one example of 3D transformation for a plurality of camera images in accordance with the techniques of this disclosure. As described above with reference to FIG. 2, 3D transform unit 220 is configured to generate a 3D voxel grid from input camera images 202. FIG. 3 shows one example of 3D transform unit 220 that uses both input point cloud 200 and input camera images 202 to generate the 3D voxel grid 221.

Encoder 320 is an image segmentation encoder that is configured to process input camera images 202 to determine camera features 322. As described above, a feature generally refers to a representation learned from the input image that captures certain patterns or characteristics of objects found in the image. For example, the features may be indicative of classes of particular types of objects in the image (e.g., cars, pedestrians, trucks, etc. for automotive applications). Encoder 320 may be part of an encoder-decoder architecture along with decoder 304.

When performing image segmentation, an encoder-decoder architecture may be configured to assign a label to every pixel in the image, such as determining whether each pixel is part of a car, a tree, or a building. The output of encoder 320 is a feature map that capture important information from the input image at varying levels of abstraction. The output of a decoder (e.g., decoder 304) may be a segmentation map, where each pixel is assigned a label. Decoder 304 upsample the feature maps to the original image size and makes pixel-wise classifications.

In the context an image segmentation encoder, encoder 320 may be configured to determine low-level, mid-level, and high-level features. In the initial layers of encoder 320 (typically convolutional layers), the network learns low-level features such as edges, colors, and simple textures. These are basic patterns that can be found in almost all images. As image data is processed deeper into the network of encoder 320, the features become more abstract. Such features might represent shapes, more complex textures, or specific arrangements of edges. At this level, the network of encoder 320 might recognize circles, stripes, or specific color patterns.

In the deeper layers of encoder 320, the features represent even more abstract concepts. For image segmentation, these might include object parts or entire objects. For example, in a network is trained to segment images typical driving environments, a high-level feature might bridges, roads, line markings, signs, car, bikes, pedestrians, and other objects or information that may be helpful in making autonomous or semi-autonomous driving decisions.

After each layer in encoder 320, there is a set of feature maps, which are essentially 2D grids (or matrices) of values. Each feature map corresponds to a particular feature learned by that layer. For instance, one feature map might highlight edges in a particular orientation, while another might highlight a specific color. Encoder 320 extracts these features, and a corresponding decoder (e.g., decoder 304) uses them to generate a segmentation map. This map assigns a label to every pixel in the input image, determining which segment or class that pixel belongs to. In essence, “features” in the context of an image segmentation encoder are the abstracted patterns and representations the network learns from the data. These features enable the network to understand and interpret the content of images, facilitating tasks like segmentation.

Decoder 304 may process camera features 322 to generate a segmentation map, including depth estimates of classes of objects determined from camera features 322. The output of decoder 304 is passed to feature concatenation unit 310 that concatenates the location/depth of objects in the segmentation map with sparse depth guidance 300. Sparse depth guidance 300 includes ground truth information of depth from different parts of the scene. The outputs of decoder 304 are estimates of the depth. To obtain the final depth map, feature concatenation unit 310 retains the regions containing the sparse depth guidance information, while for other regions, the prediction from decoder 304 is used. Sparse depth guidance 300 is obtained from input point cloud 200. The locations/depths of objects in the segmentation map output from decoder 304 may be compared with location information, including depth, found in sparse depth guidance. Because input point cloud 200 is from the same scene, the depth information in the point cloud can be used to determine depth estimates 312 of the depth of camera features 322. In some examples, sparse depth guidance 300 is not used and decoder 304 may output depth estimates from camera features 322 directly.

Instance segmentation unit 330 is an encoder-decoder architecture configured to segment objects of interest in input camera images 202 into segmented “background” and “foreground” classes 322. In this context, foreground and background are generic terms and do not necessarily convey objects that are closer to, or farther away from, the camera. Rather, foreground objects may objects of interest on which it is desired to be detected using object detection and/or image segmentation. Background objects may be objects that are not objects of interest for detection. For example, for automotive applications, foreground objects may include cars, trucks, pedestrians, signs, bridges, etc. Background objects may include distant buildings, trees, or other objects not as important for making autonomous driving decisions.

Background removal unit 340 may be configured to obtain the masks of specific foreground classes like cars, pedestrians, trucks, etc., from segmented background and foreground classes 332. Background removal unit 340 also receives camera features 322 and masks out the background objects by retaining the foreground objects using the output class estimates (e.g., segmented background and foreground classes 332) from instance segmentation unit 330. Background removal may be beneficial since camera features 322, when projected from 2D to 3D with the depth estimates 312, may result in noisy 3D voxel grid compared to the more accurate voxelized point cloud from LiDAR. In other examples or use cases, the use of instance segmentation unit 330 and background removal unit 340 may be skipped.

To obtain 3D camera features, transform unit 350 may perform BEV projection on the background removed camera features 342. Transform unit 350 may perform a BEV projection that projects background removed camera features 342 onto a 2D plane to form a 2D BEV image. Transform unit 350 then transforms the 2D BEV image into 3D voxel grid 221 using a geometric transformation. In one example, this transformation maps the 2D BEV image obtained to 3D voxel grid 221 by associating each pixel in the image with a voxel in the 3D grid. The height of each voxel in the grid is determined based on the distance of the corresponding point in the 2D image from the camera. This distance may be obtained from depth estimates 312.

In some examples, the transformation is based on a based on a Lift Splat Shoot (LSS) approach. In the context of BEV images, LSS is a pipeline for processing point cloud data. “Lift” involves lifting 2D points to a 3D space. “Splat” refers to rasterizing or projecting these 3D points back onto a 2D grid. “Shoot” usually involves using the rasterized grid to make a decision or perform an action, such as classification or object detection. This sequence allows for efficient and effective handling of point cloud data for various applications.

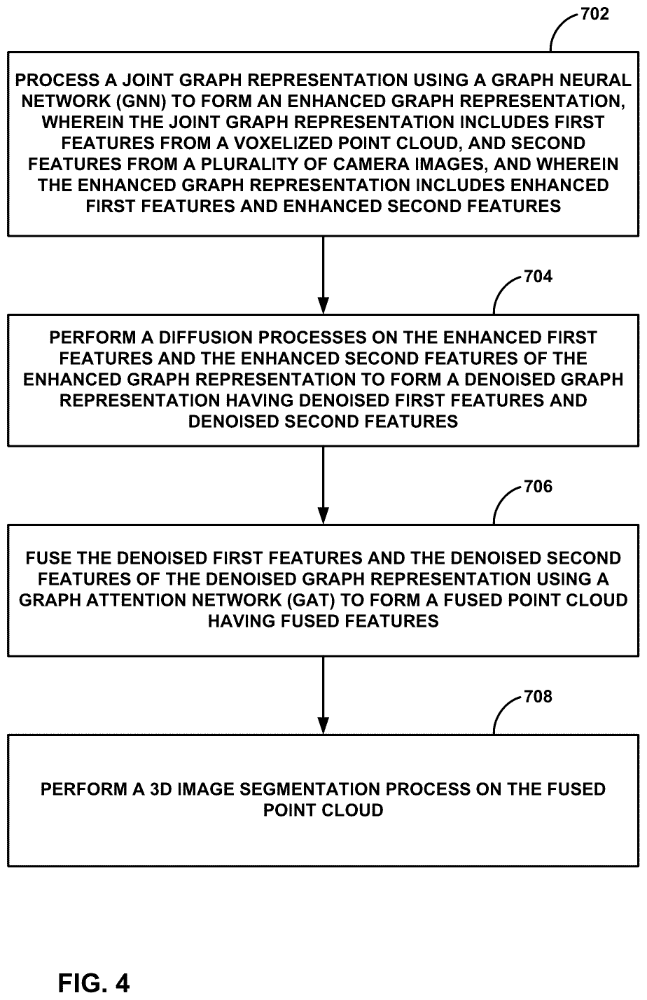

FIG. 4 is a flow diagram illustrating an example process for voxel-level fusion in accordance with an example of this disclosure. FIG. 4 is described with respect to processing system 100 and external processing system 180 of FIG. 1. However, it should be understood that the techniques of FIG. 4 may be performed by any combination of structures described herein, including voxel-level fusion 140 and segmentation unit 142 of FIG. 1 and FIG. 2 and 3D transform unit 220 of FIG. 2 and FIG. 3.

Processing system 100 may be configured to process a joint graph representation using GNN to form an enhanced graph representation (402). The joint graph representation may include first features from a voxelized point cloud, and second features from a plurality of camera images. The enhanced graph representation may include enhanced first features and enhanced second features after processing by the GNN.

In one example, processing system 100 may be configured to generate a first graph representation from the voxelized point cloud, as described above. The first graph representation includes a plurality of nodes. Processing system 100 may further be configured to generate a second graph representation from a 3D voxel grid generated from the plurality of camera images, as described above. Processing system 100 may then generate the joint graph representation having the first features and the second features from the first graph representation and the second graph representation.

In one example, the joint graph representation includes a plurality of nodes, where the plurality of nodes are associated with voxels of the voxelized point cloud and a 3D voxel grid generated from the plurality of camera images. In this example, to process the joint graph representation using the GNN to form the enhanced graph representation, processing system 100 may associate the first features and the second features with the plurality of nodes as initial node attributes. Processing system 100 may then process the initial node attributes with one or more layers of the GNN to produce the enhanced graph representation having the enhanced first features and the enhanced second features.

In some examples, processing system 100 may perform the following techniques to generate the second graph representation from the plurality of camera images. Processing system 100 may process the plurality of camera images with an image segmentation encoder to determine the second features. Processing system 100 may further process the second features using a depth estimation decoder to produce depth estimates. Processing system 100 may generate the 3D voxel grid based on the second features and the depth estimates. In other examples, processing system 100 may process the plurality of camera images with an instance segmentation encoder-decoder to generate instance segmentation masks that indicate locations of background features and foreground features in the one or more images, and remove the background features from the second features prior to generating the 3D voxel grid.

In some examples, to process the second features using the depth estimation decoder to produce the depth estimates, processing system 100 may receive depth guidance information from an input point cloud used to generate the voxelized point cloud, and process the second features using the depth estimation decoder and the depth guidance information to produce the depth estimates. In other examples, to generate the 3D voxel grid based on the second features and the depth estimates, processing system 100 may project the second features of the plurality of camera images onto a 2D plane to form projected features, and perform a geometric transformation, based on the depth estimates, to map the second features into the 3D voxel grid.

Processing system 100 may further be configured to perform a diffusion processes on the enhanced first features and the enhanced second features of the enhanced graph representation to form a denoised graph representation having denoised first features and denoised second features (404). To perform the diffusion processes on the enhanced first features and the enhanced second features of the enhanced graph representation, processing system 100 may convolve the enhanced first features and the enhanced second features of the enhanced graph representation with a diffusion kernel to form the denoised graph representation having the denoised first features and the denoised second features.

Processing system 100 may further be configured to fuse the denoised first features and the denoised second features of the denoised graph representation using a GAT to form a fused point cloud having fused features (406). In one example, the GAT comprises one or more attention layers and a fully connected layer after the one or more attention layers. In one example, to fuse the denoised first features and the denoised second features of the denoised graph representation using the GAT, processing system 100 may fuse the denoised first features and the denoised second features of the denoised graph representation using the one or more attention layers of the GAT to generate a fused graph representation, and process the fused graph representation using the fully connected layer to generate the fused point cloud having the fused features. The fused point cloud may include the fused features (e.g., class predictions) and information indicating bounding boxes around the fused features.

Processing system 100 may then be configured to perform a 3D image segmentation process on the fused point cloud (408). The 3D image segmentation process may include one or more of object detection, object classification, thresholding segmentation, region-based segmentation, edge-based segmentation, clustering-based segmentation, semantic segmentation, or instance segmentation.

Additional aspects of the disclosure are detailed in numbered clauses below.

Clause 1. An apparatus for processing image data and point cloud data, the apparatus comprising: a memory; and processing circuitry in communication with the memory, wherein the processing circuitry is configured to: process a joint graph representation using a graph neural network (GNN) to form an enhanced graph representation, wherein the joint graph representation includes first features from a voxelized point cloud, and second features from a plurality of camera images, and wherein the enhanced graph representation includes enhanced first features and enhanced second features; perform a diffusion processes on the enhanced first features and the enhanced second features of the enhanced graph representation to form a denoised graph representation having denoised first features and denoised second features; fuse the denoised first features and the denoised second features of the denoised graph representation using a graph attention network (GAT) to form a fused point cloud having fused features; and perform a 3D image segmentation process on the fused point cloud.

Clause 2. The apparatus of Clause 1, wherein the processing circuitry is further configured to: generate a first graph representation from the voxelized point cloud, the first graph representation comprising a plurality of nodes; generate a second graph representation from a three-dimensional (3D) voxel grid generated from the plurality of camera images; and generate the joint graph representation having the first features and the second features from the first graph representation and the second graph representation.

Clause 3. The apparatus of Clause 2, wherein the processing circuitry is further configured to: process the plurality of camera images with an image segmentation encoder to determine the second features; process the second features using a depth estimation decoder to produce depth estimates; and generate the 3D voxel grid based on the second features and the depth estimates.

Clause 4. The apparatus of Clause 3, wherein to process the second features using the depth estimation decoder to produce the depth estimates, the processing circuitry is further configured to: receive depth guidance information from an input point cloud used to generate the voxelized point cloud; and process the second features using the depth estimation decoder and the depth guidance information to produce the depth estimates.

Clause 5. The apparatus of any of Clauses 3-4, wherein the processing circuitry is further configured to: process the plurality of camera images with an instance segmentation encoder-decoder to generate instance segmentation masks that indicate locations of background features and foreground features in the one or more images; and remove the background features from the second features prior to generating the 3D voxel grid.

Clause 6. The apparatus of any of Clauses 3-5, wherein to generate the 3D voxel grid based on the second features and the depth estimates, the processing circuitry is further configured to: project the second features of the plurality of camera images onto a two-dimensional (2D) plane to form projected features; and perform a geometric transformation, based on the depth estimates, to map the second features into the 3D voxel grid.

Clause 7. The apparatus of any of Clauses 2-6, wherein the joint graph representation comprises a plurality of nodes, the plurality of nodes being associated with voxels of the voxelized point cloud and the 3D voxel grid generated from the plurality of camera images, and wherein to process the joint graph representation using the GNN to form the enhanced graph representation, the processing circuitry is further configured to: associate the first features and the second features with the plurality of nodes as initial node attributes; and process the initial node attributes with one or more layers of the GNN to produce the enhanced graph representation having the enhanced first features and the enhanced second features.

Clause 8. The apparatus of any of Clauses 2-6, wherein to perform the diffusion processes on the enhanced first features and the enhanced second features of the enhanced graph representation, the processing circuitry is further configured to: convolve the enhanced first features and the enhanced second features of the enhanced graph representation with a diffusion kernel to form the denoised graph representation having the denoised first features and the denoised second features.

Clause 9. The apparatus of any of Clauses 2-6, wherein the GAT comprises one or more attention layers and a fully connected layer after the one or more attention layers, and wherein to fuse the denoised first features and the denoised second features of the denoised graph representation using the GAT, the processing circuitry is further configured to: fuse the denoised first features and the denoised second features of the denoised graph representation using the one or more attention layers of the GAT to generate a fused graph representation; and process the fused graph representation using the fully connected layer to generate the fused point cloud having the fused features.

Clause 10. The apparatus of Clause 9, wherein the fused point cloud includes the fused features and information indicating bounding boxes around the fused features.

Clause 11. The apparatus of any of Clauses 1-10, where the 3D image segmentation process includes one or more of object detection, object classification, thresholding segmentation, region-based segmentation, edge-based segmentation, clustering-based segmentation, semantic segmentation, or instance segmentation.

Clause 12. The apparatus of any of Clauses 1-11, wherein the apparatus further comprises: a plurality of cameras configured to capture the plurality of camera images; and a LiDAR sensor configured to capture an input point cloud used to generate the voxelized point cloud.

Clause 13. The apparatus of Clause 12, wherein the apparatus is an automobile.

Clause 14. A method for processing image data and point cloud data, the method comprising: processing a joint graph representation using a graph neural network (GNN) to form an enhanced graph representation, wherein the joint graph representation includes first features from a voxelized point cloud, and second features from a plurality of camera images, and wherein the enhanced graph representation includes enhanced first features and enhanced second features; performing a diffusion processes on the enhanced first features and the enhanced second features of the enhanced graph representation to form a denoised graph representation having denoised first features and denoised second features; fusing the denoised first features and the denoised second features of the denoised graph representation using a graph attention network (GAT) to form a fused point cloud having fused features; and performing a 3D image segmentation process on the fused point cloud.

Clause 15. The method of Clause 14, further comprising: generating a first graph representation from the voxelized point cloud, the first graph representation comprising a plurality of nodes; generating a second graph representation from a three-dimensional (3D) voxel grid generated from the plurality of camera images; and generating the joint graph representation having the first features and the second features from the first graph representation and the second graph representation.

Clause 16. The method of Clause 15, further comprising: processing the plurality of camera images with an image segmentation encoder to determine the second features; processing the second features using a depth estimation decoder to produce depth estimates; and generating the 3D voxel grid based on the second features and the depth estimates.

Clause 17. The method of Clause 16, wherein processing the second features using the depth estimation decoder to produce the depth estimates comprises: receiving depth guidance information from an input point cloud used to generate the voxelized point cloud; and processing the second features using the depth estimation decoder and the depth guidance information to produce the depth estimates.

Clause 18. The method of any of Clauses 16-17, further comprising: processing the plurality of camera images with an instance segmentation encoder-decoder to generate instance segmentation masks that indicate locations of background features and foreground features in the one or more images; and removing the background features from the second features prior to generating the 3D voxel grid.

Clause 19. The method of any of Clauses 16-18, wherein generating the 3D voxel grid based on the second features and the depth estimates comprises: projecting the second features of the plurality of camera images onto a two-dimensional (2D) plane to form projected features; and performing a geometric transformation, based on the depth estimates, to map the second features into the 3D voxel grid.

Clause 20. The method of any of Clauses 15-19, wherein the joint graph representation comprises a plurality of nodes, the plurality of nodes being associated with voxels of the voxelized point cloud and the 3D voxel grid generated from the plurality of camera images, and wherein processing the joint graph representation using the GNN to form the enhanced graph representation comprises: associating the first features and the second features with the plurality of nodes as initial node attributes; and processing the initial node attributes with one or more layers of the GNN to produce the enhanced graph representation having the enhanced first features and the enhanced second features.

Clause 21. The method of any of Clauses 15-20, wherein performing the diffusion processes on the enhanced first features and the enhanced second features of the enhanced graph representation comprises: convolving the enhanced first features and the enhanced second features of the enhanced graph representation with a diffusion kernel to form the denoised graph representation having the denoised first features and the denoised second features.

Clause 22. The method of any of Clauses 15-21, wherein the GAT comprises one or more attention layers and a fully connected layer after the one or more attention layers, and wherein fusing the denoised first features and the denoised second features of the denoised graph representation using the GAT comprises: fusing the denoised first features and the denoised second features of the denoised graph representation using the one or more attention layers of the GAT to generate a fused graph representation; and processing the fused graph representation using the fully connected layer to generate the fused point cloud having the fused features.

Clause 23. The method of Clause 22, wherein the fused point cloud includes the fused features and information indicating bounding boxes around the fused features.

Clause 24. The method of any of Clauses 14-23, where the 3D image segmentation process includes one or more of object detection, object classification, thresholding segmentation, region-based segmentation, edge-based segmentation, clustering-based segmentation, semantic segmentation, or instance segmentation.

Clause 25. A non-transitory computer-readable storage medium storing instructions that, when executed, causes one or more processors of a device configured to process image data and point cloud data to: process a joint graph representation using a graph neural network (GNN) to form an enhanced graph representation, wherein the joint graph representation includes first features from a voxelized point cloud, and second features from a plurality of camera images, and wherein the enhanced graph representation includes enhanced first features and enhanced second features; perform a diffusion processes on the enhanced first features and the enhanced second features of the enhanced graph representation to form a denoised graph representation having denoised first features and denoised second features; fuse the denoised first features and the denoised second features of the denoised graph representation using a graph attention network (GAT) to form a fused point cloud having fused features; and perform a 3D image segmentation process on the fused point cloud.

Clause 26. The non-transitory computer-readable storage medium of Clause 25, wherein the instructions further cause the one or more processors to: generate a first graph representation from the voxelized point cloud, the first graph representation comprising a plurality of nodes; generate a second graph representation from a three-dimensional (3D) voxel grid generated from the plurality of camera images; and generate the joint graph representation having the first features and the second features from the first graph representation and the second graph representation.

Clause 27. The non-transitory computer-readable storage medium of Clause 26, wherein the joint graph representation comprises a plurality of nodes, the plurality of nodes being associated with voxels of the voxelized point cloud and the 3D voxel grid generated from the plurality of camera images, and wherein to process the joint graph representation using the GNN to form the enhanced graph representation, the instructions further cause the one or more processors to: associate the first features and the second features with the plurality of nodes as initial node attributes; and process the initial node attributes with one or more layers of the GNN to produce the enhanced graph representation having the enhanced first features and the enhanced second features.

Clause 28. The non-transitory computer-readable storage medium of any of Clauses 26-27, wherein to perform the diffusion processes on the enhanced first features and the enhanced second features of the enhanced graph representation, the instructions further cause the one or more processors to: convolve the enhanced first features and the enhanced second features of the enhanced graph representation with a diffusion kernel to form the denoised graph representation having the denoised first features and the denoised second features.

Clause 29. The non-transitory computer-readable storage medium of any of Clauses 26-28, wherein the GAT comprises one or more attention layers and a fully connected layer after the one or more attention layers, and wherein to fuse the denoised first features and the denoised second features of the denoised graph representation using the GAT, the instructions further cause the one or more processors to: fuse the denoised first features and the denoised second features of the denoised graph representation using the one or more attention layers of the GAT to generate a fused graph representation; and process the fused graph representation using the fully connected layer to generate the fused point cloud having the fused features, wherein the fused point cloud includes the fused features and information indicating bounding boxes around the fused features.

Clause 30. The non-transitory computer-readable storage medium of any of Clauses 25-29, where the 3D image segmentation process includes one or more of object detection, object classification, thresholding segmentation, region-based segmentation, edge-based segmentation, clustering-based segmentation, semantic segmentation, or instance segmentation.

Clause 31. An apparatus for processing image data and point cloud data, the apparatus comprising: means for processing a joint graph representation using a graph neural network (GNN) to form an enhanced graph representation, wherein the joint graph representation includes first features from a voxelized point cloud, and second features from a plurality of camera images, and wherein the enhanced graph representation includes enhanced first features and enhanced second features; means for performing a diffusion processes on the enhanced first features and the enhanced second features of the enhanced graph representation to form a denoised graph representation having denoised first features and denoised second features; means for fusing the denoised first features and the denoised second features of the denoised graph representation using a graph attention network (GAT) to form a fused point cloud having fused features; and means for performing a 3D image segmentation process on the fused point cloud.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for processing image data and point cloud data, the apparatus comprising:
a memory; and
processing circuitry in communication with the memory, wherein the processing circuitry is configured to:
process a joint graph representation using a graph neural network (GNN) to form an enhanced graph representation, wherein the joint graph representation includes first features from a voxelized point cloud, and second features from a plurality of camera images, and wherein the enhanced graph representation includes enhanced first features and enhanced second features;
perform a diffusion processes on the enhanced first features and the enhanced second features of the enhanced graph representation to form a denoised graph representation having denoised first features and denoised second features;
fuse the denoised first features and the denoised second features of the denoised graph representation using a graph attention network (GAT) to form a fused point cloud having fused features; and
perform a 3D image segmentation process on the fused point cloud.

2. The apparatus of claim 1, wherein the processing circuitry is further configured to:
generate a first graph representation from the voxelized point cloud, the first graph representation comprising a plurality of nodes;
generate a second graph representation from a three-dimensional (3D) voxel grid generated from the plurality of camera images; and
generate the joint graph representation having the first features and the second features from the first graph representation and the second graph representation.

3. The apparatus of claim 2, wherein the processing circuitry is further configured to:
process the plurality of camera images with an image segmentation encoder to determine the second features;
process the second features using a depth estimation decoder to produce depth estimates; and
generate the 3D voxel grid based on the second features and the depth estimates.

4. The apparatus of claim 3, wherein to process the second features using the depth estimation decoder to produce the depth estimates, the processing circuitry is further configured to:
receive depth guidance information from an input point cloud used to generate the voxelized point cloud; and
process the second features using the depth estimation decoder and the depth guidance information to produce the depth estimates.

5. The apparatus of claim 3, wherein the processing circuitry is further configured to:
process the plurality of camera images with an instance segmentation encoder-decoder to generate instance segmentation masks that indicate locations of background features and foreground features in the one or more images; and
remove the background features from the second features prior to generating the 3D voxel grid.

6. The apparatus of claim 3, wherein to generate the 3D voxel grid based on the second features and the depth estimates, the processing circuitry is further configured to:
project the second features of the plurality of camera images onto a two-dimensional (2D) plane to form projected features; and
perform a geometric transformation, based on the depth estimates, to map the second features into the 3D voxel grid.

7. The apparatus of claim 2, wherein the joint graph representation comprises a plurality of nodes, the plurality of nodes being associated with voxels of the voxelized point cloud and the 3D voxel grid generated from the plurality of camera images, and wherein to process the joint graph representation using the GNN to form the enhanced graph representation, the processing circuitry is further configured to:
associate the first features and the second features with the plurality of nodes as initial node attributes; and
process the initial node attributes with one or more layers of the GNN to produce the enhanced graph representation having the enhanced first features and the enhanced second features.

8. The apparatus of claim 2, wherein to perform the diffusion processes on the enhanced first features and the enhanced second features of the enhanced graph representation, the processing circuitry is further configured to:
convolve the enhanced first features and the enhanced second features of the enhanced graph representation with a diffusion kernel to form the denoised graph representation having the denoised first features and the denoised second features.

9. The apparatus of claim 2, wherein the GAT comprises one or more attention layers and a fully connected layer after the one or more attention layers, and wherein to fuse the denoised first features and the denoised second features of the denoised graph representation using the GAT, the processing circuitry is further configured to:
fuse the denoised first features and the denoised second features of the denoised graph representation using the one or more attention layers of the GAT to generate a fused graph representation; and
process the fused graph representation using the fully connected layer to generate the fused point cloud having the fused features.

10. The apparatus of claim 9, wherein the fused point cloud includes the fused features and information indicating bounding boxes around the fused features.

11. The apparatus of claim 1, where the 3D image segmentation process includes one or more of object detection, object classification, thresholding segmentation, region-based segmentation, edge-based segmentation, clustering-based segmentation, semantic segmentation, or instance segmentation.

12. The apparatus of claim 1, wherein the apparatus further comprises:
a plurality of cameras configured to capture the plurality of camera images; and
a LiDAR sensor configured to capture an input point cloud used to generate the voxelized point cloud.

13. The apparatus of claim 12, wherein the apparatus is an automobile.

14. A method for processing image data and point cloud data, the method comprising:
processing a joint graph representation using a graph neural network (GNN) to form an enhanced graph representation, wherein the joint graph representation includes first features from a voxelized point cloud, and second features from a plurality of camera images, and wherein the enhanced graph representation includes enhanced first features and enhanced second features;
performing a diffusion processes on the enhanced first features and the enhanced second features of the enhanced graph representation to form a denoised graph representation having denoised first features and denoised second features;
fusing the denoised first features and the denoised second features of the denoised graph representation using a graph attention network (GAT) to form a fused point cloud having fused features; and
performing a 3D image segmentation process on the fused point cloud.

15. The method of claim 14, further comprising:
generating a first graph representation from the voxelized point cloud, the first graph representation comprising a plurality of nodes;
generating a second graph representation from a three-dimensional (3D) voxel grid generated from the plurality of camera images; and
generating the joint graph representation having the first features and the second features from the first graph representation and the second graph representation.

16. The method of claim 15, further comprising:
processing the plurality of camera images with an image segmentation encoder to determine the second features;
processing the second features using a depth estimation decoder to produce depth estimates; and
generating the 3D voxel grid based on the second features and the depth estimates.

17. The method of claim 16, wherein processing the second features using the depth estimation decoder to produce the depth estimates comprises:
receiving depth guidance information from an input point cloud used to generate the voxelized point cloud; and
processing the second features using the depth estimation decoder and the depth guidance information to produce the depth estimates.

18. The method of claim 16, further comprising:
processing the plurality of camera images with an instance segmentation encoder-decoder to generate instance segmentation masks that indicate locations of background features and foreground features in the one or more images; and
removing the background features from the second features prior to generating the 3D voxel grid.

19. The method of claim 16, wherein generating the 3D voxel grid based on the second features and the depth estimates comprises:
projecting the second features of the plurality of camera images onto a two-dimensional (2D) plane to form projected features; and
performing a geometric transformation, based on the depth estimates, to map the second features into the 3D voxel grid.

20. The method of claim 15, wherein the joint graph representation comprises a plurality of nodes, the plurality of nodes being associated with voxels of the voxelized point cloud and the 3D voxel grid generated from the plurality of camera images, and wherein processing the joint graph representation using the GNN to form the enhanced graph representation comprises:
associating the first features and the second features with the plurality of nodes as initial node attributes; and
processing the initial node attributes with one or more layers of the GNN to produce the enhanced graph representation having the enhanced first features and the enhanced second features.

21. The method of claim 15, wherein performing the diffusion processes on the enhanced first features and the enhanced second features of the enhanced graph representation comprises:
convolving the enhanced first features and the enhanced second features of the enhanced graph representation with a diffusion kernel to form the denoised graph representation having the denoised first features and the denoised second features.

22. The method of claim 15, wherein the GAT comprises one or more attention layers and a fully connected layer after the one or more attention layers, and wherein fusing the denoised first features and the denoised second features of the denoised graph representation using the GAT comprises:
fusing the denoised first features and the denoised second features of the denoised graph representation using the one or more attention layers of the GAT to generate a fused graph representation; and
processing the fused graph representation using the fully connected layer to generate the fused point cloud having the fused features.

23. The method of claim 22, wherein the fused point cloud includes the fused features and information indicating bounding boxes around the fused features.

24. The method of claim 14, where the 3D image segmentation process includes one or more of object detection, object classification, thresholding segmentation, region-based segmentation, edge-based segmentation, clustering-based segmentation, semantic segmentation, or instance segmentation.

25. A non-transitory computer-readable storage medium storing instructions that, when executed, causes one or more processors of a device configured to process image data and point cloud data to:
process a joint graph representation using a graph neural network (GNN) to form an enhanced graph representation, wherein the joint graph representation includes first features from a voxelized point cloud, and second features from a plurality of camera images, and wherein the enhanced graph representation includes enhanced first features and enhanced second features;
perform a diffusion processes on the enhanced first features and the enhanced second features of the enhanced graph representation to form a denoised graph representation having denoised first features and denoised second features;
fuse the denoised first features and the denoised second features of the denoised graph representation using a graph attention network (GAT) to form a fused point cloud having fused features; and
perform a 3D image segmentation process on the fused point cloud.

26. The non-transitory computer-readable storage medium of claim 25, wherein the instructions further cause the one or more processors to:
generate a first graph representation from the voxelized point cloud, the first graph representation comprising a plurality of nodes;
generate a second graph representation from a three-dimensional (3D) voxel grid generated from the plurality of camera images; and
generate the joint graph representation having the first features and the second features from the first graph representation and the second graph representation.

27. The non-transitory computer-readable storage medium of claim 26, wherein the joint graph representation comprises a plurality of nodes, the plurality of nodes being associated with voxels of the voxelized point cloud and the 3D voxel grid generated from the plurality of camera images, and wherein to process the joint graph representation using the GNN to form the enhanced graph representation, the instructions further cause the one or more processors to:
associate the first features and the second features with the plurality of nodes as initial node attributes; and
process the initial node attributes with one or more layers of the GNN to produce the enhanced graph representation having the enhanced first features and the enhanced second features.

28. The non-transitory computer-readable storage medium of claim 26, wherein to perform the diffusion processes on the enhanced first features and the enhanced second features of the enhanced graph representation, the instructions further cause the one or more processors to:
convolve the enhanced first features and the enhanced second features of the enhanced graph representation with a diffusion kernel to form the denoised graph representation having the denoised first features and the denoised second features.

29. The non-transitory computer-readable storage medium of claim 26, wherein the GAT comprises one or more attention layers and a fully connected layer after the one or more attention layers, and wherein to fuse the denoised first features and the denoised second features of the denoised graph representation using the GAT, the instructions further cause the one or more processors to:
fuse the denoised first features and the denoised second features of the denoised graph representation using the one or more attention layers of the GAT to generate a fused graph representation; and
process the fused graph representation using the fully connected layer to generate the fused point cloud having the fused features, wherein the fused point cloud includes the fused features and information indicating bounding boxes around the fused features.

30. The non-transitory computer-readable storage medium of claim 25, where the 3D image segmentation process includes one or more of object detection, object classification, thresholding segmentation, region-based segmentation, edge-based segmentation, clustering-based segmentation, semantic segmentation, or instance segmentation.
